(19) United States
(12) Patent Application Publication
(10) Pub. No.: US 2002/0090935 A1
(43) Pub. Date: Jul. 11, 2002

(54) Portable communication terminal and method of transmitting/receiving e-mail messages

(75) Inventor: Takeshi Anzai, Saitama (JP)

Correspondence Address: YOUNG & THOMPSON, 745 SOUTH 23RD STREET 2ND FLOOR, ARLINGTON, VA, 22202

(73) Assignee: NEC CORPORATION, Tokyo (JP)

(21) Appl. No.: 10/036,402

(22) Filed: Jan. 7, 2002

(30) Foreign Application Priority Data
Jan. 5, 2001 (JP) 2001-000667

(51) Int. Cl. H04M 11/10

(52) U.S. Cl. 455/412; 455/550; 455/461

(57) ABSTRACT

A method of transmitting/receiving e-mail messages is provided, which makes it possible to transmit and receive e-mail messages with an increased power of expression. In a transmitting portable communication terminal, (a-1) characters are inputted to form a character data for an e-mail message. (a-2) Additional expression data for the character data is inputted, the additional expression data giving a variation of expression on the respective characters of the character data. (a-3) A transmission data is generated by linking the character data with the additional expression data and by converting the character data and the additional expression data thus linked to the transmission data. (a-4) The transmission data is transmitted by radio to a recipient as e-mail. In a receiving portable communication terminal, (b-1) the transmission data transmitted by radio from the transmitting portable communication terminal as e-mail is received. (b-2) The character data and the additional expression data are regenerated from the transmission data received in the step (b-1) (b-3) The characters of the character data regenerated in the step (b-2) are displayed on a screen according to the additional expression data regenerated in the step (b-2).

### BACKGROUND OF THE INVENTION

1. Field of the Invention

The present invention relates to a portable communication terminal, such as a portable telephone, having a function of transmitting and/or receiving messages by electronic mail (e-mail) More particularly, the invention relates to a portable communication terminal of this type capable of representing an increased power of expression according to the sender's feelings or intention in e-mail communication, and a method of transmitting/receiving e-mail messages with an increased power of expression according to the sender's feelings or intention on a portable communication terminal.

2. Description of the Related Art

In recent years, communication manners using portable communication terminals such as portable telephones have been diversifying. Responsive to this tendency, not only verbal or speech communication but also e-mail communication using portable terminals of this type have become popular so far. From this point of view, the improvement for e-mail communication performance has become more important for these terminals.

Conventionally, various techniques relating to e-mail communication or e-mail delivery on portable communication terminals have been developed and disclosed. For example, the Japanese Non-Examined Patent Publication No. 2000-299699 published in October 2000 discloses a system and method for delivering e-mail on a portable communication terminal. This system has a purpose or intention to summarize the content or message of e-mail received to form a compact message, thereby making it possible for the user to read out the e-mail message on the narrow screen of a portable communication terminal. This system comprises a character extracting means for extracting specific character strings from an e-mail message, and a summarizing means for summarizing the character strings extracted by the character extracting means to a compact message displayable on the screen of a portable communication terminal by converting the respective character strings thus extracted to compact characters or figures. The compact message thus formed is displayed on the screen of the terminal by a display means.

However, the above-described system for delivering e-mail disclosed by the Publication No. 2000-299699 has the following problems.

Specifically, as described previously, not only speech communication but also e-mail communication using a portable telephone have become popular and thus, the performance improvement for e-mail communication has become more important for portable telephones.

Usually, e-mail commnunication is carried out by transmitting and receiving a set of characters (i.e., a text) only. Therefore, the sender's message sent by e-mail has insufficient power of expression about the sender's feelings for the recipient, compared with speech communication. To decrease or relax this disadvantage, pictorial symbols (e.g., so-called icons or emoticons) have often been added to the sender's message. However, the addition of pictorial symbols is still insufficient and dissatisfactory for the users or e-mail. There is the going demand to increase the power of expression in e-mail messages even on portable communication terminals.

On the other hand, there is a type of portable communication terminals having a function of reading the received e-mail message aloud with a speaker. However, this reading function produces and emits simply an audible sound or voice in a monotone according to the message Thus, it is unable to say that the sender's feelings are satisfactorily expressed in the sound or voice thus emitted.

### SUMMARY OP THE INVENTION

Accordingly, an object of the present invention is to provide a portable communication terminal capable of producing messages with an increased power of expression and of transmitting the messages thus produced by e-mail.

Another object of the present invention is to provide a portable communication terminal capable of receiving messages sent by e-mail and of reproducing the messages thus received with an increased power of expression.

Still another object of the present invention is to provide a method of transmitting/receiving e-mail messages that makes it possible to transmit and receive e-mail messages with an increased power of expression.

The above objects together with others not specifically mentioned will become clear to those skilled in the art from the following description.

According to a first aspect of the invention, a portable communication terminal with a function of transmitting e-mail is provided, which comprises:

(a) a first input device for inputting characters to form a character data for an e-mail message;

(b) a second input device for inputting an additional expression data for the character data;

the additional expression data giving a variation of expression on the respective characters of the character data;

(c) a transmission data generator for generating a transmission data by linking the character data with the additional expression data and by converting the character data and the additional expression data thus linked to the transmission data; and

(d) a radio device for transmitting the transmission data by radio to a recipient as e-mail.

With the portable communication terminal according to the first aspect of the invention, if the user of the terminal (i.e., the sender) wants to send an e-mail message to a desired recipient, the user inputs by the first input device desired characters to make his/her e-mail message, forming the character data for the message. Moreover, the user inputs by the second input device to the additional expression data for the character data for the message according to the user's intention.

Since the additional expression data gives a variation of expression on the respective characters of the character data, the user can define the content of the additional expression data to be inputted as desired while taking his/her feeling or intention into consideration.

The transmission data generator generates the transmission data by linking the character data with the additional expression data and by converting the character data and the additional expression data thus linked to the transmission data. The transmission data thus generated is transmitted by the radio device to the recipient as e-mail.

As a result, the transmission data thus transmitted from the portable communication terminal according to the first aspect of the invention can give the recipient the e-mail message with an increased power of expression on the user's or sender's feelings.

In a preferred embodiment of the terminal according to the first aspect, keys or buttons provided on the terminal are used as at least one of the first and second input devices.

In another preferred embodiment of the terminal according to the first aspect, a microphone is used as at least one of the first and second input devices.

In still another preferred embodiment of the terminal according to the first aspect, the additional expression data represents at least one of size, color, and font of the respective characters of the character data.

In a further preferred embodiment of the terminal according to the first aspect, the additional expression data represents at least one of tone, stress, accent, and intonation of voice to be generated according to the respective characters of the character data.

According to a second aspect of the invention, another portable communication terminal with a function of receiving e-mail is provided, which comprises:

(a) a radio device for receiving a transmission data transmitted by radio as e-mail from a sender;

the transmission data containing a character data and an additional expression data for the character data;

the character data being linked with the additional expression data;

the character data being formed by characters for an e-mail message;

the additional expression data giving a variation of expression on the respective characters of the character data;

(b) a reception data regenerator for regenerating the character data and the additional expression data from the transmission data received by the radio device; and

(c) a display device with a screen;

the display device displaying the characters of the character data regenerated by the reception data regenerator on the screen according to the additional expression data regenerated by the reception data regenerator.

With the portable communication terminal according to the second aspect of the invention, the radio device receives the transmission data transmitted by radio as e-mail from the sender. The transmission data contains a character data and an additional expression data for the character data. The character data is linked with the additional expression data. The character data is formed by characters for an e-mail message. The additional expression data gives a variation of expression on the respective characters of the character data.

Then, the reception data regenerator regenerates the character data and the additional expression data from the transmission data received by the radio device. The display device displays the characters of the character data regenerated by the reception data regenerator on the screen according to the additional expression data regenerated by the reception data regenerator.

As a result, the transmission data thus received by the portable communication terminal according to the second aspect of the invention can give the recipient the e-mail message with an increased power of expression on the user's or sender's feelings.

In a preferred embodiment of the terminal according to the second aspect, the additional expression data represents at least one of size, color, and font of the characters of the character data. The display device displays the characters of the character data on the screen while changing the at least one of size, color, and font of the respective characters of the character data according to the additional expression data.

In another preferred embodiment of the terminal according to the second aspect, a character-voice converter for converting the character data to a voice data, and a voice generator for generating a voice according to the voice data are additionally provided. The additional expression data represents at least one of tone, stress, accent, and intonation of the voice. The voice generator generates a voice while changing the at least one of tone, stress, accent, and intonation of the voice according to the additional expression data.

According to a third aspect of the invention, a method of transmitting/receiving e-mail messages between portable communication terminals is provided, which comprises the steps of:

(a) in a transmitting portable communication terminal;

(a-1) inputting characters to form a character data for an e-mail message;

(a-2) inputting additional expression data for the character data;

the additional expression data giving a variation of expression on the respective characters of the character data;

(a-3) generating a transmission data by linking the character data with the additional expression data and by converting the character data and the additional expression data thus linked to a transmission data; and

(a-4) transmitting the transmission data by radio to a recipient as e-mail: and

(b) in a receiving portable communication terminal;

(b-1) receiving the transmission data transmitted by radio from the transmitting portable communication terminal as e-mail;

(b-2) regenerating the character data and the additional expression data from the transmission data received in the step (b-1); and

(b-3) displaying the characters of the character data regenerated in the step (b-2) on a screen according to the additional expression data regenerated in the step (b-2).

With the method of transmitting/receiving e-mail messages between portable communication terminals according to the third aspect of the invention, the operation of the portable communication terminal according to the first aspect and the operation of the portable communication terminal according to the second aspect are combined together. Therefore, e-mail messages with an increased power of expression can be transmitted and received.

### BRIEF DESCRIPTION OF THE DRAWINGS

In order that the present invention may be readily carried into effect, it will now be described with reference to the accompanying drawings.

FIG. 1 is a schematic, functional block diagram showing the use and configuration of a transmitting portable telephone and a receiving portable telephone according to a first embodiment of the invention.

FIG. 2 is a schematic diagram showing the configuration and data processing method in the transmitting portable telephone according to the first embodiment of the FIG. 1.

FIG. 3A is a schematic diagram showing the use of the input device for inputting the character data in the transmitting portable telephone according to the first embodiment of FIG. 1.

FIG. 3B is a schematic diagram showing the use of the input device for inputting the additional expression data in the transmitting portable telephone according to the first embodiment of FIG. 1.

FIG. 4 is a schematic diagram showing the configuration and data processing method in the receiving portable telephone according to the first embodiment of the FIG. 1.

FIG. 5 is a schematic, functional block diagram showing the use and configuration of a transmitting portable telephone and a receiving portable telephone according to a second embodiment of the invention.

FIG. 6 is a schematic diagram showing the use of the input device for inputting the character data and the additional expression data in the transmitting portable telephone according to the second embodiment of FIG. 5.

FIG. 7 is a schematic diagram showing the use of the input device for inputting the character data and the additional expression data in a transmitting portable telephone according to a third embodiment of the invention.

FIG. 8 is a schematic diagram showing the appearance of the transmitting/receiving portable telephone according to the first, second and third embodiments of FIGS. 1, 5, and 7.

### DETAILED DESCRIPTION OF THE PREFERRED EMBODIMENTS

Preferred embodiments of the present invention will be described in detail below while referring to the drawings attached.

### First Embodiment

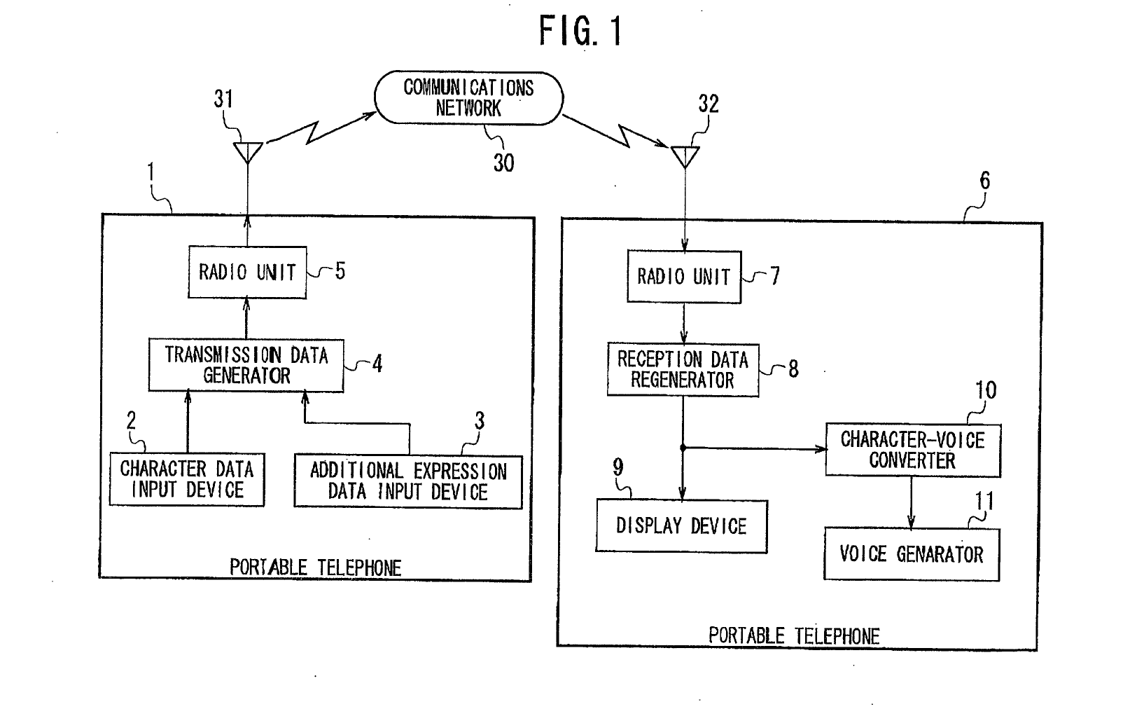

A transmitting portable telephone 1 and a receiving portable telephone 6 according to a first embodiment of the invention have the configuration as shown in FIG. 1. It is needless to say that each of the telephones 1 and 6 has a function of ordinary speech communication. However, this function is not related to the invention. Thus, no explanation is presented here for the speech function while the explanation about the function of e-mail communication is made below.

The transmitting portable telephone 1 comprises a character data input device 2, an additional expression data input device 3, a transmission data generator 4, a radio unit or device 5, and an antenna 31. The telephone 1 has a function of transmitting e-mail messages by radio.

The receiving portable telephone 6 comprises an antenna 32, a radio unit or device 7, a reception data regenerator 8, a display device 9, a character-voice converter 10, and a voice generator 11. The telephone 6 has a function of receiving e-mail messages transmitted by radio.

The reference numeral 30 denotes a communications network for interconnecting the transmitting and receiving telephones 1 and 6 by radio.

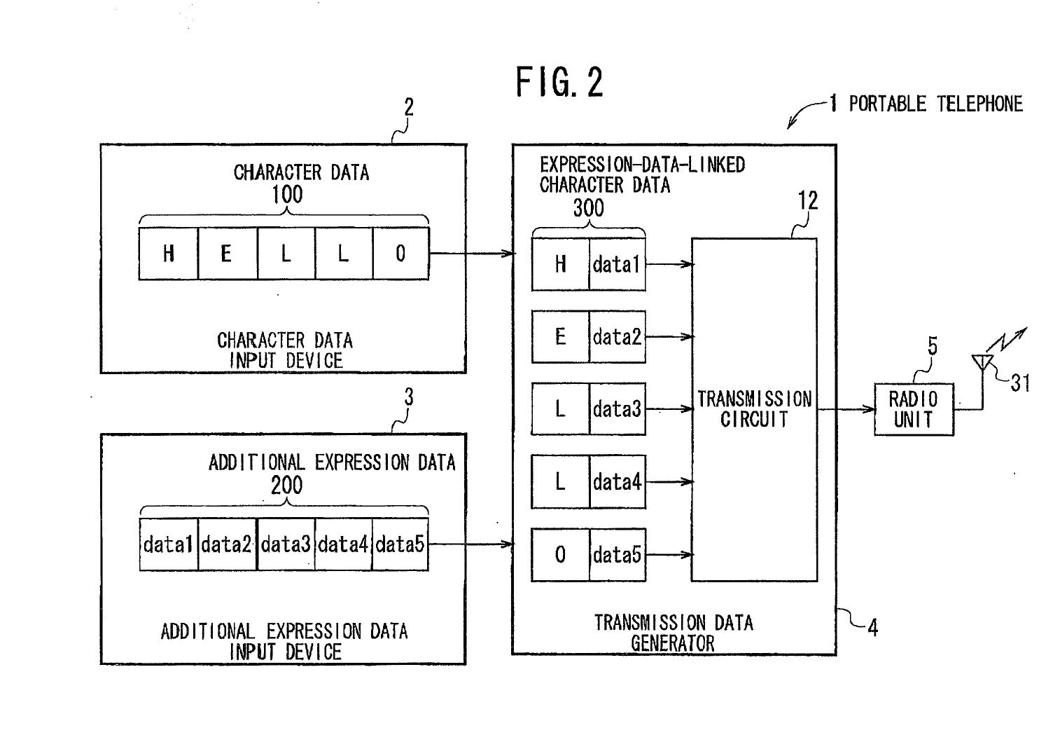

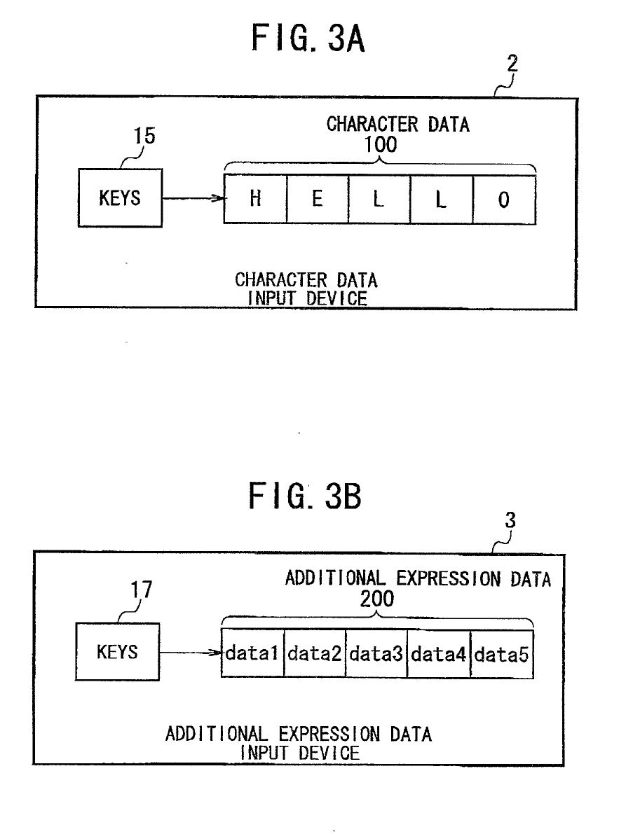

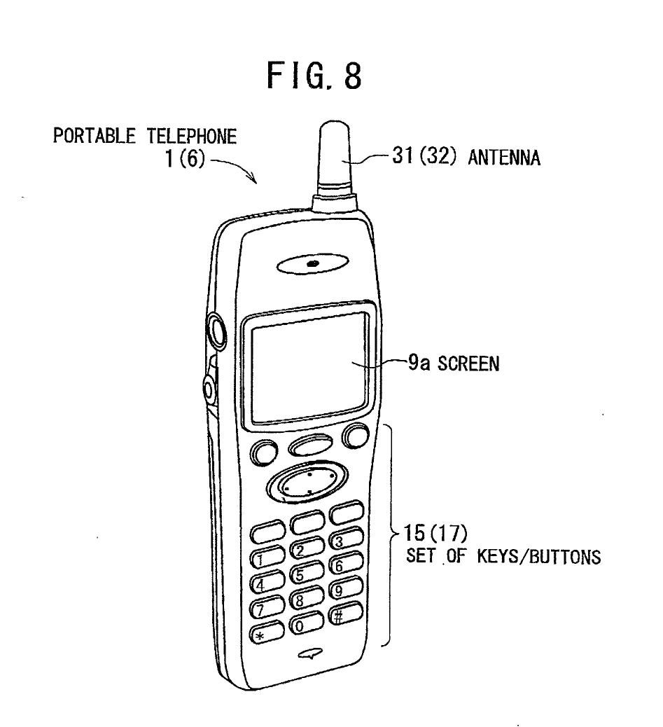

In the transmitting telephone 1, the character data input device 2 is used for inputting characters to form a character data 100 for an e-mail message according to the user's necessity, as shown in FIG. 2. The device 2 includes a set of keys 15, as shown in FIG. 3A. As the set of keys 15, a set of keys or buttons provided on the telephone 1 shown in FIG. 8 are preferably used.

The additional data expression data input device 3 is used for inputting an additional expression data 200 for the character data for the e-mail message, as shown in FIG. 2. The additional expression data gives a variation of expression on the respective characters of the character data 100. The device 2 includes a set of keys 17, as shown in FIG. 3B. As the set of keys 17, the set of keys or buttons provided on the telephone 1 shown in FIG. 8 are preferably used.

To generate a specific transmission data, the transmission data generator 4 operates to link the character data 100 inputted by the input device 2 with the additional expression data 200 inputted by the input device 3, thereby forming an expression-data-linked character data 300, as shown in FIG. 2. Thereafter, the expression-data-linked character data 300 is sent to a transmission circuit 12 of the generator 4, thereby converting the data 300 to the transmission data in the form according to the RCR-27 standard for the Time Division Multiple Access technology.

The radio device or unit 5 receives the transmission data and transmits it from the antenna 31 to a recipient, i.e., the receiving portable telephone 6, by radio through the network 30 as e-mail.

In the receiving telephone 6, the radio unit or device 7 receives the transmission data transmitted from the telephone 1 as e-mail through the antenna 32. Then, the unit 7 sends the transmission data thus received to the reception data regenerator 8.

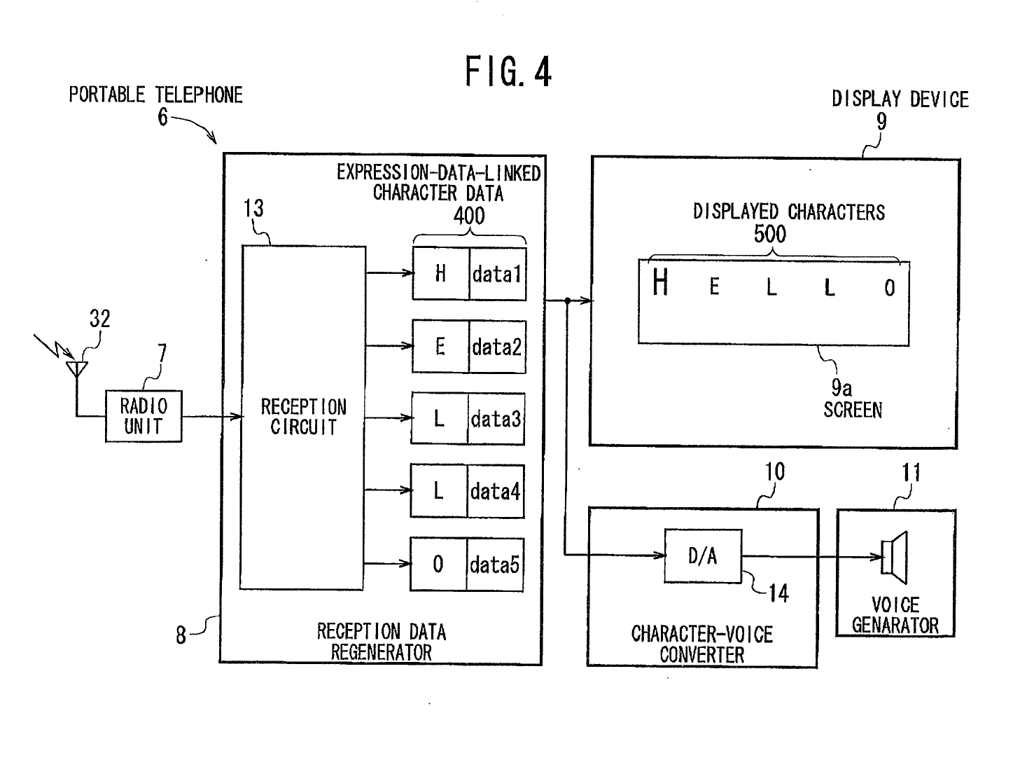

The reception data regenerator 8 receives the transmission data from the radio unit 7 in a reception circuit 13 of the regenerator 8 and then, regenerates a reception data from the transmission data. Thus, an expression-data-linked character data 400 is formed, as shown in FIG. 4. The data 400 includes the character data 100 and the additional expression data 200 transmitted from the transmitting telephone 1. In other words, the data 400 corresponds to the expression-data-linked character data 300 generated in the transmission data generator 4 of the telephone 1.

The display device 9 has a screen 9a on which specific functional or instructing information or the like is displayed with the use of characters, figures, and/or symbols as necessary. The screen 9a is usually provided on the front surface of the body of the telephone 6, as shown in FIG. 8. The display device 9 receives the expression-data-linked character data 400 formed by the reception data regenerator 8. Then, in response to the data 400, the device 9 displays the characters in the character data 100 on the screen 9a in the specific expression manner according to the additional expression data 200.

The character-voice converter 10 is used for reproducing the characters of the character data 100 in the form of voice or sound, not for reproducing them on the screen 9a. This is selectable for the user of the telephone 6. The converter 10 receives the expression-data-linked character data 400 thus formed by the reception data regenerator 8 in a digital-to-analog (D/A) converter 14, thereby converting the digital data 400 to an analog voice data in a specific form applicable to the voice generator 11. In this way, the converter 10 conducts its conversion operation for the data 400.

The voice generator 11 receives the analog voice data generated in the character-voice converter 10 and then, generates a synthetic voice according to the voice data. The voice thus generated is emitted from a speaker 15 provided in the generator 11. The information represented by the voice thus emitted corresponds to the sound of the characters of the character data 100 to be displayed in the screen 9a. The information thus outputted in the form of voice is in the specific expression manner according to the additional expression data 200.

Next, the operation of the transmitting telephone 1 is explained below with reference to FIGS. 2, 3A and 3B.

Here, as shown in FIGS. 2, 3A and 3B, it is supposed that the user of the telephone 1 (i.e., the sender of e-mail) has an intention to transmit a short, simple character string “HELLO” by e-mail to the user of the telephone 6 (i.e., the recipient of e-mail). In this case, the user of the telephone 1 chooses the e-mail mode and then, operates the input device 2 (i.e., the keys or buttons 15) to input the desired character string “HELLO” into the telephone 1. The character string “HELLO” is the characters that form the character data 100.

On the other hand, the user operates the input device 3 (i.e., the keys or buttons 17) to input the desired additional expression data 200 for the character string “HELLO” into the telephone 1 character by character. Specifically, the user inputs “data 1”, “data 2”, “data 3”, “data 4”, “data 5” for the respective characters “H”, “E”, “L”, “L”, “O” with the device 3 as their additional expression data 200.

For example, the additional expression data 200 is used to define or choose the size of characters. In this case, the size of characters to be used for e-mail messages is divided into 9 levels or steps and then, the first to ninth levels on character size are assigned to the numeric keys “1” to “9” of the set of keys 17, respectively. The user operates the keys “1” to “9” to specify the size of the individual characters “H”, “E”, “L”, “L”, and “O” from the first to ninth levels according to his/her intention or desire. Here, it is supposed that the size of the character “H” alone is specified at the largest, ninth level while the size of the remaining characters “E”, “L”, “L”, and “O” are specified at the middle, fifth level.

Thereafter, the transmission data generator 4 operates to link the character data 100 (i., “H”, “E”, “L”, “L”, and “O”) thus inputted with the additional expression data 200 (“data 1”, “data 2”, “data 3”, “data 4 ”, and “data 5”) thus specified, thereby forming the expression-data-linked character data 300, as shown in FIG. 2. Moreover, the data 300 is sent to the transmission circuit 12 to convert the data 300 to the transmission data in the form according to the RCR-27 standard.

The radio device or unit 5 transmits the transmission data thus formed through the antenna 31 to the receiving portable telephone 6 by radio through the network 30 as e-mail.

Next, the operation of the receiving telephone 6 is explained below with reference to FIG. 4.

In the receiving telephone 6, the radio unit or device 7 receives the transmission data transmitted from the telephone 1 as e-mail through the antenna 32. Then, the unit 7 sends the transmission data thus received to the reception data regenerator 8.

The reception data regenerator 8 receives the transmission data from the radio unit 7 in the reception circuit 13, thereby regenerating the reception data. Thus, an expression-data-linked character data 400 is formed, as shown in FIG. 4. Since the data 400 corresponds to the expression-data-linked character data 300, the data 400 includes the character data 100 (i.e., “H”, “E”, “L”, “L”, and “0”) and the additional expression data 200 (“data 1”, “data 2”, “data 3”, “data 4”, and “data 5”) from the telephone 1.

The display device 9 receives the expression-data-linked character data 400 formed by the reception data regenerator 8. Then, in response to the data 400, the device 9 displays the transmitted characters “H”, “E”, “L”, “L”, and “O” on the screen 9a. These characters are displayed in the specific expression manner according to the additional expression data 200.

Specifically, as described above, the size of the character “H” alone is specified at the largest, ninth level while the size of the remaining characters “E”, “L”, “L”, and “O” are specified at the middle, fifth level. Therefore, the characters “H”, “E”, “L”, “L”, and “O” transmitted from the sender's telephone 1 are displayed on the screen 9a with their specified size, as shown in FIG. 4.

In the first embodiment, the additional expression data 200 represents the size of the characters. However, the data 200 may represent any other elements for modifying the characters. For example, the color and/or font of the characters may be specified by the data 200 along with the size of the characters.

The characters “H”, “E”, “L”, “L” and “O” of the character data 100 may he converted to a voice and emitted from the speaker 15. In this case, the voice may be designed to emit a sound to read but the individual characters or to read out the word constituted by the characters.

If the user of the receiving telephone 6 has an intention to hear the character data 100 in the form of voice, he/she chooses the voice mode, in which the character-voice converter 10 and the voice generator 11 are activated.

In this case, the character-voice converter 10 receives the expression-data-linked character data 400 thus formed by the reception data regenerator 8 in the D/A converter 14, thereby converting the digital data 400 to the analog voice data in a specific form applicable to the voice generator 11. out The voice generator 11 receives the analog voice data generated in the converter 10 and then, generates the synthetic voice according to the voice data. The voice thus generated is emitted from the speaker 15 in the generator 11.

The information represented by the voice thus emitted is the characters “H”, “E”, “L”, “L” and “O” themselves, or the word “HELLO” constituted by these characters. The information thus outputted in the form of voice is outputted in the specific expression manner according to the additional expression data 200. The data may represent at least one of tone, stress, accent, and intonation of voice to be generated.

With the transmitting telephone 1 according to the first embodiment of FIGS. 1, 2, 3A and 3B, as explained above, if the user of the transmitting telephone 1 wants to send an e-mail message to the user of the receiving telephone 6 (i.e., the recipient), the user of the telephone 1 inputs by the input device 2 desired characters to make his/her e-mail message, forming the character data 100 for the message. Moreover, the user of the telephone 1 inputs by the input device 3 to the additional expression data 200 for the character data 100 for the message according to the his or her intention.

Since the additional expression data 200 gives a variation of expression on the respective characters of the character data 100, the user of the telephone 1 can define the content of the additional expression data 200 to be inputted as desired while taking his/her feeling or intention into consideration.

The transmission data generator 4 links the character data 100 with the additional expression data 200, thereby forming the expression-data-linked character data 300. Then, the generator 4 converts the expression-data-linked character data 300 thus formed to the transmission data. The transmission data thus generated is then transmitted by the radio unit 5 to the receiving telephone 6 as e-mail.

As a result, the transmission data thus transmitted from the telephone 1 can give the recipient (i.e., the user of the receiving telephone 6) the e-mail message with an increased power of expression on the sender's feelings, compared with the conventional e-mail messages including characters only.

On the other hand, with the receiving telephone 6 according to the first embodiment, the radio unit 7 receives the transmission data transmitted by radio as e-mail from the telephone 1. The transmission data contains the character data 100 and the additional expression data 200 for the character data 100.

Then, the reception data regenerator 8 regenerates the character data 100 and the additional expression data 200 from the transmission data received by the radio unit 7. The display device 9 displays the characters of the character data 100 regenerated by the regenerator 8 on the screen 9a according to the additional expression data 200 regenerated by the regenerator 8.

As a result, the transmission data thus received by the telephone 6 according to the first embodiment can give the user of the telephone 6 (i.e., the recipient) the e-mail message with an increased power of expression on the sender's feelings, compared with the conventional e-mail messages including characters only.

### Second Embodiment

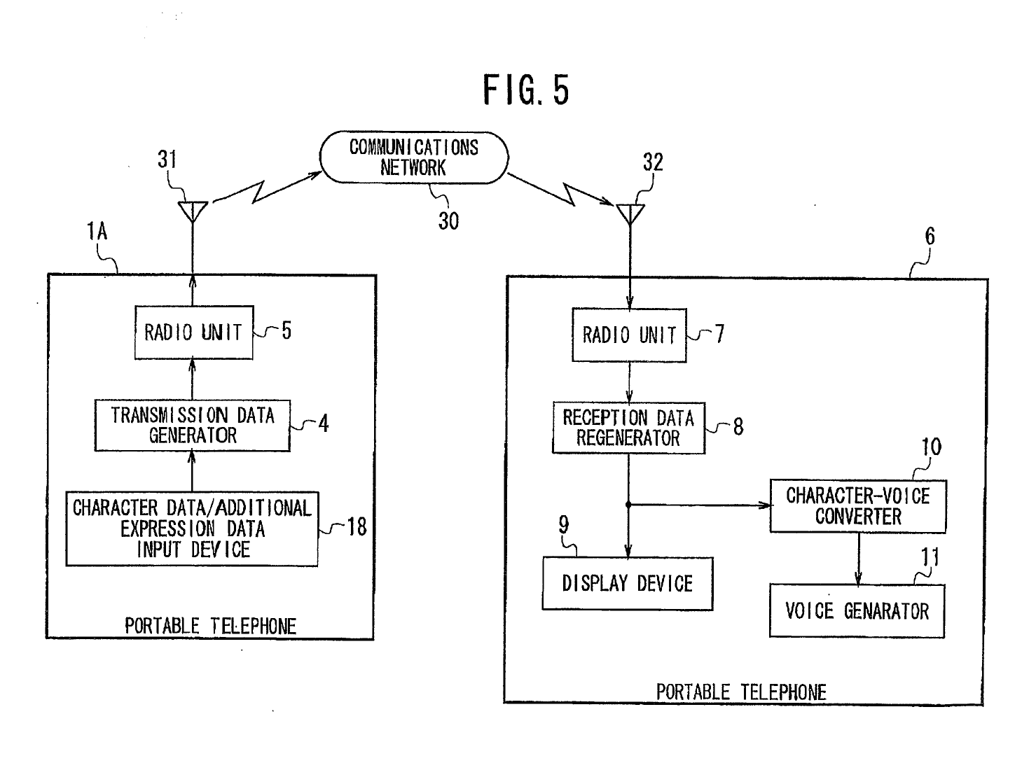

FIG. 5 shows a transmitting portable telephone 1A according to a second embodiment of the invention, in which the receiving portable telephone 6 according to the first embodiment is shown.

The telephone 1A of the second embodiment has the same configuration as the telephone 1 of the first embodiment of FIG. 1, except that a character data/additional expression data input device 18 is used instead of the character data input device 2 and the additional expression data input device 3. Therefore, no explanation is presented here for the same configuration by attaching the same reference numerals to those of the first embodiment.

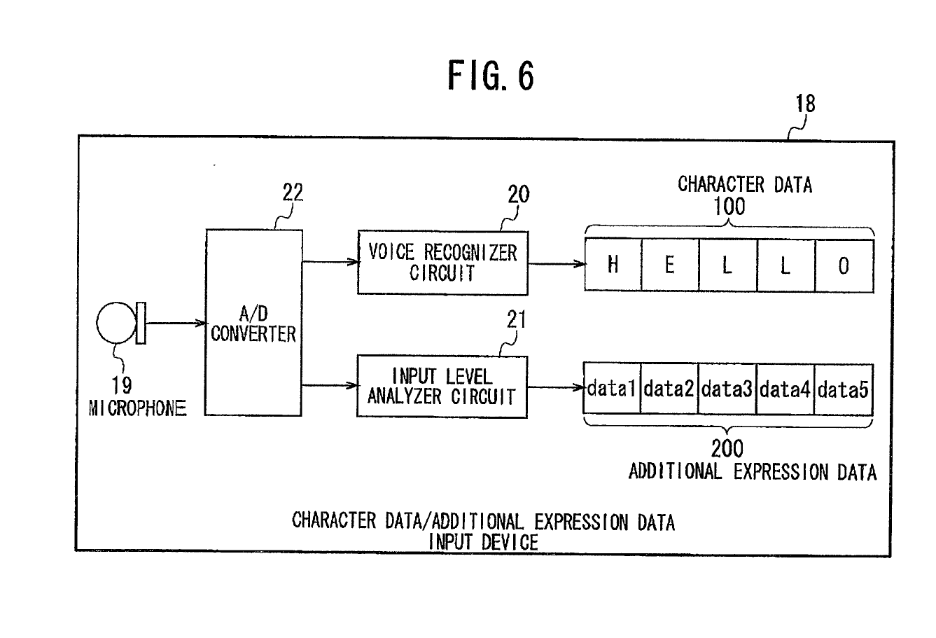

The character data/additional expression data input device 18 has the configuration as shown in FIG. 6. Specifically, the input device 18 comprises a microphone 19, an A/D converter 22, a voice recognizer circuit 20, and an input level analyzer circuit 21.

The microphone 19 receives the user's voice to input desired characters for the character data 100, thereby forming an analog voice signal.

The A/D converter 22 receives the analog voice signal from the microphone 19 and converts it to a digital voice signal.

The voice recognizer circuit 20 receives the digital voice signal from the converter 22 and recognizes the characters represented by the voice signal, thereby forming the character data 100 (e .g. HELLO).

The input level analyzer circuit 21 receives the digital voice signal from the converter 22 and analyzes the input level of the voice signal, thereby forming the additional expression data 200 (e.g., “data 1”, “data 2”, “data 3”, “data 4”, and “data 5”). By analyzing the input level of the voice signal, the difference in intensity of the user's voice can be identified at several levels. According to the intensity levels of the voice thus identified, the content of the “data 1”, “data 2”, “data 3”, “data 4”, and “data 5” is determined or assigned.

The operation of the receiving telephone 6 is the same as that of the first embodiment and thus, no explanation is presented here.

With the transmitting telephone 1A according to the second embodiment, there are the same advantages as those of the telephone 1 of the first embodiment.

### Third Embodiment

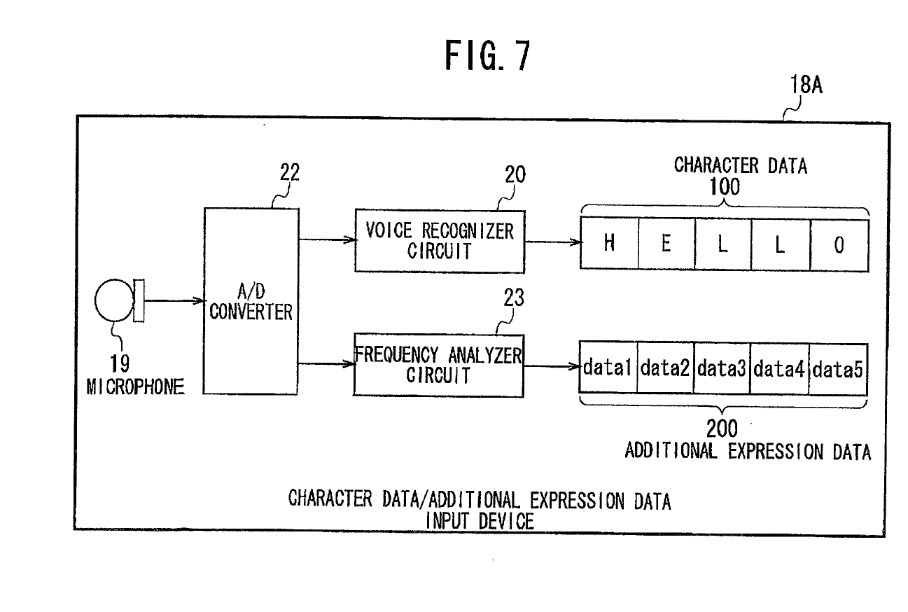

FIG. 7 shows the configuration of a character data/additional expression data input device 18A used in a telephone according to a third embodiment of the invention, which is a variation of the second embodiment.

The character data/additional expression data input device 18A has the same configuration as the device 18 except that a frequency analyzer circuit 23 is provided instead of the input level analyzer circuit 21. Therefore, the explanation about the same configuration is omitted by attaching the same reference numerals to the same elements in FIG. 7.

The frequency analyzer circuit 23 receives the digital voice signal from the A/D converter 22 and analyzes the frequency of the voice signal, thereby forming the additional expression data 200 (e.g., “data 1”, “data 2”, “data 3”, “data 4”, and “data 5”). By analyzing the frequency of the voice signal, the difference in tone or intonation of the user's voice can be identified at several levels. According to the tone or intonation levels of the voice thus identified, the content of the “data 1”, “data 2”, “data 3”, “data 4”, and “data 5” is determined or assigned.

The operation of the receiving telephone 6 is the same as that of the first embodiment and thus, no explanation is presented here.

With the transmitting telephone according to the third embodiment, it is obvious that there are the same advantages as those of the telephone 1A of the second embodiment.

In the above-described first to third embodiments, for the sake of facilitating the explanation, the transmitting telephone is explained to have only the transmitting means of e-mail while the receiving telephone is made to have only the receiving means of e-mail. It is needless to say that an ordinary portable telephone comprises both of the transmitting and receiving means of e-mail.

### Variations

Needless to say, the present invention is not limited to the above-described first and second embodiments. Any change or modification may be added to these embodiments within the spirit of the invention.

For example, the invention is applied to portable telephones in the above embodiments. However, the invention may be applied to any other type of portable communication terminals.

While the preferred forms of the present invention has been described, it is to be understood that modifications will be apparent to those skilled in the art without departing from the spirit of the invention. The scope of the present invention, therefore, is to be determined solely by the following claims.

What is claimed is:

1. A portable communication terminal with a function of transmitting e-mail, comprising:
(a) a first input device for inputting characters to form a character data for an e-mail message;
(b) a second input device for inputting an additional expression data for the character data;
the additional expression data giving a variation of expression on the respective characters of the character data;
(c) a transmission data generator for generating a transmission data by linking the character data with the additional expression data and by converting the character data and the additional expression data thus linked to the transmission data; and
(d) a radio device for transmitting the transmission data by radio to a recipient as e-mail.

2. The terminal according to claim 1, wherein keys or buttons provided on the terminal are used as at least one of the first and second input devices.

3. The terminal according to claim 1, wherein a microphone is used as at least one of the first and second input devices.

4. The terminal according to claim 1, wherein the additional expression data represents at least one of size, color, and font of the respective characters of the character data.

5. The terminal according to claim 1, wherein the additional expression data represents at least one of tone, stress, accent, and intonation of voice to be generated according to the respective characters of the character data.

6. A portable communication terminal with a function of receiving e-mail, comprising:
(a) a radio device for receiving a transmission data transmitted by radio as e-mail from a sender;
the transmission data containing a character data and an additional expression data for the character data;
the character data being linked with the additional expression data;
the character data being formed by characters for an e-mail message;
the additional expression data giving a variation of expression on the respective characters of the character data;
(b) a reception data regenerator for regenerating the character data and the additional expression data from the transmission data received by the radio device; and
(c) a display device with a screen;
the display device displaying the characters of the character data regenerated by the reception data regenerator on the screen according to the additional expression data regenerated by the reception data regenerator.

7. The terminal according to claim 6, wherein the additional expression data represents at least one of size, color, and font of the characters of the character data;
and wherein the display device displays the characters of the character data on the screen while changing the at least one of size, color, and font of the respective characters of the character data according to the additional expression data.

8. The terminal according to claim 6, further comprising;
a character-voice converter for converting the character data to a voice data; and
a voice generator for generating a voice according to the voice data are additionally provided;
wherein the additional expression data represents at least one of tone, stress, accent, and intonation of the voice;
and wherein the voice generator generates a voice while changing the at least one of tone, stress, accent, and intonation of the voice according to the additional expression data.

9. A method of transmitting/receiving e-mail messages between portable communication terminals, the method comprising the steps of:
(a) in a transmitting portable communication terminal;
(a-1) inputting characters to form a character data for an e-mail message;
(a-2) inputting additional expression data for the character data;
the additional expression data giving a variation of expression on the respective characters of the character data;
(a-3) generating a transmission data by linking the character data with the additional expression data and by converting the character data and the additional expression data thus linked to the transmission data; and
(a-4) transmitting the transmission data by radio to a recipient as e-mail: and
(b) in a receiving portable communication terminal;
(b-1) receiving the transmission data transmitted by radio from the transmitting portable communication terminal as e-mail;
(b-2) regenerating the character data and the additional expression data from the transmission data received in the step (b-1); and
(b-3) displaying the characters of the character data regenerated in the step (b-2) on a screen according to the additional expression data regenerated in the step (b-2).

10. The method according to claim 9, wherein keys or buttons provided on the transmitting terminal are used to conduct at lest one of the steps (a-1) and (a-2).

11. The method according to claim 9, wherein a microphone is used to conduct at lest one of the steps (a-1) and (a-2).

12. The method according to claim 9, wherein the additional expression data represents at least one of size, color, and font of the respective characters of the character data.

13. The method according to claim 12, wherein the display device displays the characters of the character data on the screen while changing the at least one of size, color, and font of the respective characters of the character data according to the additional expression data.

14. The method according to claim 9, wherein the additional expression data represents at least one of tone, stress, accent, and intonation of voice to be generated according to the respective characters of the character data.

15. The method according to claim 14, wherein the receiving terminal further comprises
a character-voice converter for converting the character data to a voice data; and
a voice generator for generating a voice according to the voice data are additionally provided;
and wherein the voice generator generates a voice while changing the at least one of tone, stress, accent, and intonation of the voice according to the additional expression data.
